(19) United States
(12) Patent Application Publication
(10) Pub. No.: US 2009/0012835 A1
(43) Pub. Date: Jan. 8, 2009

(54) Methods for Increased Compensation for Hourly Wage Employees

(76) Inventors: Tim GORCZYCA, San Antonio, TX (US); Monica L. Gorczyca, San Antonio, TX (US)

Correspondence Address: KAMMER BROWNING PLLC, 7700 BROADWAY, SUITE 202, SAN ANTONIO, TX, 78209, US

(21) Appl. No.: 11/773,986

(22) Filed: Jul. 6, 2007

(51) Int. Cl. G06Q 10/00; G06F 17/40

(52) U.S. Cl. 705/9

(57) ABSTRACT

Three interrelated methods are presented for providing increased compensation of hourly wage and salaried employees based upon performance requirements and results. The present invention includes methods for increasing employee compensation based upon hourly wage multipliers defined by seasonal, daily, and conditional factors. The methods further include the process guaranteeing the resources necessary for the completion of a specific job. A comparison is made between the nominally defined resources required for the job and the actual resources available, with the actual resources available (the employees) receiving increased compensation based upon the difference between the nominal resources and the actual resources. Finally, increased compensation methods may be based upon identified performance factors and the measurement of actual performance levels that exceed base performance levels. The methods described may be interrelated to calculate an increased compensation for a specific employee based upon modification of a base hourly wage or a salary reduced to an hourly wage, according to each of the processes described.

### BACKGROUND OF THE INVENTION

1. Field of the Invention

The present invention relates generally to methods for determining compensation for hourly wage and salaried employees. The present invention relates more specifically to computer assisted methods for calculating employee pay based upon increased compensation for specific performance-based activities and events.

2. Description of the Related Art

Most employees in the United States and in other industrialized countries are currently being compensated on an hourly basis. This means that the workers are paid according to an hourly wage regardless of how much or how little work is actually performed during the time period. In many instances, specific jobs may have several workers receiving the same hourly wage, while some of the workers may be doing more than their share of the work over a specific period of time. Some jobs may require that hourly wage employees perform additional functions during certain time periods yet receive the same hourly wage for performing such functions.

Most hourly wage employees rely on minimum wage rules and basic labor laws for their incentives. Many such hourly wage workers perform only the minimum amount of work that is required for them to keep their job. In many instances this is because of low or very little supervision. The result is that many of these workers show feelings of poor self-esteem, little self-confidence, lack of prestige or importance, and little or no respect. Many of these negative feelings have a direct motivational impact upon output and production on the job. In turn, these personal counterproductive motivational forces have a direct impact on the financial bottom line for the businesses involved. While some efforts have been made in the past to incorporate profit sharing as a motivational factor for hourly wage employees, such efforts have fallen short for a variety of reasons. Most commonly, profit sharing methods of compensation are delayed or displaced significantly in time from the actual performance of work. That is, compensation occurs at some later date disconnected with the work being performed. Such profit sharing often takes the form of end-of-the-year bonuses based upon job performances that have occurred throughout the year. It is difficult for an hourly wage employee to associate increased performance at any particular moment in time with such delayed compensation in the form of a year-end bonus.

It would be desirable to have a computer assisted interactive process for employee compensation that would deliver immediately observable results that include; (1) a more equitable distribution of hourly wages paid according to the actual amount of work performed during an increment of time; (2) a more energized work force due to the perception that the work performed is valued, which will in turn cause positive feelings about the work and an overall respect for the workers; (3) a reduction in labor costs due to a more efficient use of labor and the use of multipliers that will immediately compensate a worker for time increments when greater functional demands are placed on a worker; (4) a general increase in overall job performance or sales due to the use of sales or performance incentives; (5) a reduction in worker turnover deriving from a tendency to retain an existing employee thereby elevating work place job knowledge and proficiency; (6) a reduction in new employee orientation, training, and on-the-job labor training costs necessary to instill performance proficiency for a specified job at hand; (7) a reduction in overall labor costs due to a more efficient, defined utilization of hourly worker job performance, ultimately resulting in an increase in worker compensation as well as an increase in business profits.

### SUMMARY OF THE INVENTION

In fulfillment of the above described objectives, the present invention provides a number of interrelated methods for increased compensation of hourly wage and salaried employees based upon performance requirements and results. The present invention includes methods for increasing employee compensation based upon hourly wage multipliers defined by seasonal, daily, and conditional factors. The methods further include the process of guaranteeing the resources necessary for the completion of a specific job. A comparison is made between the nominally defined resources required for the job and the actual resources available, with the actual resources available (the employees) receiving increased compensation based upon the difference between the nominal resources and the actual resources. Finally, increased compensation methods may be based upon identified performance factors and the measurement of actual performance levels that exceed base performance levels. The methods described may be interrelated to calculate an increased compensation for a specific employee based upon modification of a base hourly wage, or a salary reduced to an hourly wage, according to each of the processes described.

### BRIEF DESCRIPTION OF THE DRAWINGS

FIG. 1 is a flow chart showing the steps associated with the method of the present invention with the use of hourly wage multipliers.

FIG. 2 is a flow chart showing the steps associated with the method of the present invention with the process of guaranteeing the resource.

FIG. 3 is a flow chart showing the steps associated with the method of the present invention with the process of identifying increased sales performance.

### DETAILED DESCRIPTION OF THE PREFERRED EMBODIMENTS

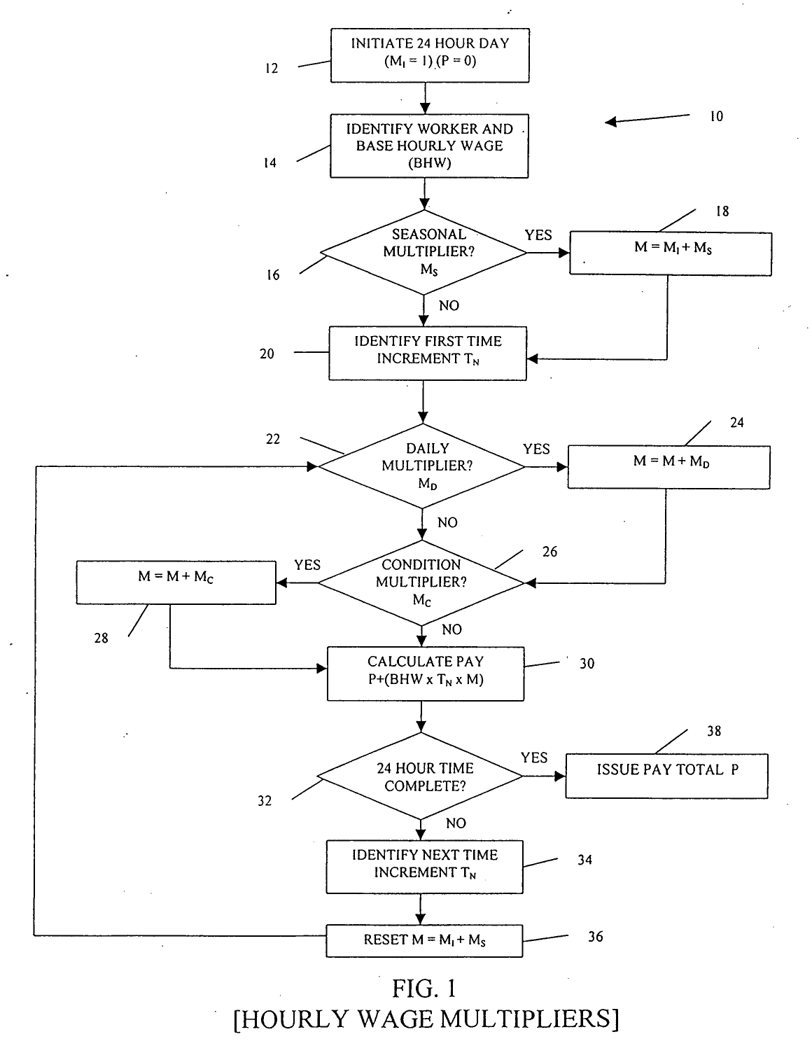

Reference is made first to FIG. 1 for a detailed description of the steps associated with determining an increased compensation based upon hourly wage multipliers. Method (10) provides a mechanism for increasing the hourly wage of an employee based upon specific events or environmental conditions encountered by the employee within the scope of his or her employment. The process is based on a twenty-four (24) hour day determination but relates to variables that are cyclical on a yearly basis or on any of a number of other time recurring bases.

The method described on FIG. 1 is carried out by a data processing system on a real time basis. In order to implement the methods of the present invention, it is necessary to retain information regarding employees hourly wages and working conditions as well as carry out the necessary calculations associated with identifying increased compensation on the basis of specific time increments during the 24-hour day. It is understood that a 24-hour period could start at any time during the day or night and is not tied to a midnight to midnight day. The process described in FIG. 1, therefore, would be carried out according to a data processing system having appropriate time keeping devices and data input devices, such as are commonly found on job sites having hourly wage employees. Such equipment includes not only central processing systems but employee input devices for identifying arrivals and departures from the job, as well as timing devices for identifying the specific day, dates, and times that work is being carried out. There would, in addition, be an input device that would permit the employer to identify and input extraneous factors not maintained in memory that could affect increased wage compensation totals.

### Hourly Wage Multipliers

The method (10) shown in FIG. 1 begins with step (12) wherein a 24-hour day is initiated. In step (12) the multiplier (M_{I}) is initially set to a factor of 1 and the pay (P) during the 24-hour day is initially set to 0. In step (14) the data processor identifies the worker and that worker's base hourly wage (BHW). It is anticipated that many workers can be handled by a single data processing system with each worker's compensation being calculated in turn. In addition, each worker's base hourly wage (BHW) could be variable depending upon other traditional factors such as seniority, experience, etc.

In step (16) the data processor determines whether or not a seasonal multiplier (M_{S}) should be in place. A seasonal multiplier could be any of a number of factors that relate to the specific day/date on which work is being performed. Examples of seasonal multipliers are provided in Table 1 and most commonly would include such seasonal conditions as increased customer traffic on certain holidays during the year. If a seasonal multiplier is in place for the specific day/date under consideration, method (10) proceeds to step (18) wherein multiplier (M) is defined as the sum of initial multiplier (M_{I}) and the amount of the seasonal multiplier (M_{S}).

Step (20) involves identifying a first time increment (T_{N}) during the 24-hour day. This first time increment is defined as a first period of time over which a consistent hourly wage multiplier would apply. The time increment may be set as a first hour or some fraction of an hour. A particular employer may choose to vary the time increment according to the conditions associated with the job. In most instances, a minimum time increment of 0.25 hours would be appropriate. Under other job conditions, a time increment of one (1) hour may be appropriate. The basic time increment for determining hourly wage multipliers will depend upon the timing of the factors that serve to increase the hourly wage multiplier as described in more detail below.

For a first time increment, (T_{N}) the data processor determines in step (22) whether a daily multiplier, (M_{D}) should apply. Examples of daily multipliers are provided in Table 1 and include events that occur on a daily basis that serve to make a particular job more or less difficult than on average during the day. Such events might typically include time periods of an increase in customer traffic or servicing difficulties. Such events also include time periods of increased mental or physical focus by the employee. If the data processor determines that a daily multiplier should apply to the specific time increment (T_{N}) in question, then the multiplier (M) for that time period is incremented at step (24) by daily multiplier (M_{D}).

TABLE 1

SEASONAL MULTIPLIERS
Increased Customer “Traffic”
Increased Customer “Hostility”
Birthday Bonus
Anniversary Bonus
Fiscal Year Deadlines
DAILY MULTIPLIERS
Morning Traffic
Lunchtime Traffic
Evening Traffic
“Launch” Timed Events
Mental Focus Events
Physical Focus Events
Overtime
CONDITION MULTIPLIERS
Momentary Customer Increase
Utility Failure/Outage
Unexpected Deadline
Transportation Failure
Communication Failure
Data Processing Failure

Finally, the data processor determines in step (26) whether there are specific conditions that are in existence at the time in question that would require the use of a condition multiplier (M_{C}). Such specific conditions are typically unanticipated events that are not retained in the data processor memory but which are input by an employer as conditions dictate. Examples of such condition multipliers are also given in Table 1. If a condition multiplier does exist, data processor increments the multiplier (M) at step (28) by the condition multiplier (M_{C}).

The incremented multiplier (M) is thereafter used to calculate the pay for the specific time increment at step (30). This calculation accumulates pay (P) by the amount of the base hourly wage times the time increment (T_{N}) times the multiplier (M) according to the equation P=P+(BHW×T_{N}×N).

At step (32) the data processor determines whether the 24-hour time period has been completed. If not, the processor identifies the next time increment (T_{N}) at step (34). The process then returns to step (22) after resetting multiplier (M) equal to the initial multiplier (1 in most cases) plus the seasonal multiplier (M_{S}) at step (36). If at step (32) the 24-hour time period is complete, the processor proceeds to step (38) where it issues a pay total (P) for the employee in question.

In general, the process described in FIG. 1 lends itself to a number of variations. The noted time frames could be increments of hours or minutes or a combination of both. For example, seven hours and thirty minutes, four hours and ten minutes, or forty-five minutes.

Daily compensation is computed and based on the total amount of time actually worked during the 24-hour period multiplied by a pre-determined hourly wage. The optional multipliers are included and affect cumulative daily compensation totals over four, six, eight, ten hours or any pre-determined increment of time. Examples would include a multiplier 1.5 (time and a half) for additional cumulative hours and/or minutes worked over eight hours within a 24-hour period. Other examples include a multiplier of 1.25 (time and a quarter) for additional cumulative hours and/or minutes worked over six hours within a 24-hour daily period.

Multipliers may, of course, be other amounts; 1.125, 1.35, 1.50, 1.65, 1.95, etc. Such multipliers may be used for all hours during a day or for certain hour increments worked during a given 24-hour period of time. Examples of daily multipliers could include the hours worked between 11:00 p.m. and 7:00 a.m. or hours worked between 11:30 a.m. to 1:30 p.m., 5:00 p.m. to 6:30 p.m., etc. Different multiplier values may be plugged into different increments of time within a 24-hour period. The variety of multiplier values will be generally based upon the increase or decrease of the functional demands placed on the worker during such specific increments of time.

Other examples of optional multiplier assignments and the justification for such assignments include the following.

A. Package Delivery

Delivery drivers typically unload their deliveries for the day from a conveyor belt coming out of a large truck. They watch the boxes go past on a conveyor belt and are expected to pull such boxes off if the packages are part of their route. This function is very demanding and stressful. It would therefore be appropriate to have a multiplier of 1.75 for the hours of 6:00 a.m. to 7:30 a.m. (hourly wage×1.75×1.5 hours).

B. Nursing Attendant

Under nursing home conditions, and in some hospital environments, nursing attendants are assigned to wake residents for breakfast at about 6:00 a.m. This process involves extra coordination, movement, and an increase in functional demands placed upon and expected of the nursing attendant before the end of the shift. Such an increase in functional demands for the last one hour increment in the shift includes bringing many residents to the dining room after they are dressed, washed, and otherwise cared for. Such a function could warrant a 1.6 multiplier for the one hour period of time of increased functional demands (hourly wage×1.6×1.0 hours).

C. Food Service Employees

Cooks in healthcare facilities have routine duties related to the preparation of meals for most of their shift when functioning as a cook. However, when it comes to actual serving time, the functional demands are greatly increased, as well as the performance expectations. A major portion of the meals served to residents in healthcare facilities, for example, are calculated diets. The stress placed on such food service providers at serving time is increased according to the accountability associated with such calculated diets. The cooks must read the diet cards for each of the residents with the calculated diets, and then translate the information into serving the correct quantity of food items for that particular physician-ordered, calculated diet without making an error in the quantity calculation of the food items for the particular diet that they are serving. Such service occurs over an increment of time typically on the order of an hour and a half. A multiplier of 2.0 might be appropriate for that 90-minute increment of time (hourly wage×2.0×1.5 hours).

At other times during a typical work day, food service facilities receive shipments of food items that are put into the pantry after they are unloaded. Such a job function for the food service provider is an increase in attention demand that may warrant a multiplier of 1.25 over the particular increment of time. Sometimes this function can take two hours, or more (hourly wage×1.25×2.0 hours).

D. Birthday/Anniversary Bonuses

Various multipliers may be entered for workers who work on their birthday or on other anniversaries that occur during the year. These could include employment anniversaries or other annual events specific to the individual worker. Multipliers of 1.5, 2.0, 2.5, or whatever the employer chooses may be implemented.

E. Retail Sales

Around the biggest holiday shopping seasons retail sales clerks are typically subjected to increased job demands. Instead of hiring additional employees to meet the influx of holiday shoppers, the employer can add a multiplier, 1.6 for example, for the increased functional demands placed upon the permanent employees. Recognizing the permanent employee in this way would generate elevated self-worth, and would produce more efficient sales transactions due to the permanent employee becoming more product proficient and informed.

Retail stores are typically flooded with returns after holiday buying periods of time. Major performance demands are placed upon exchange clerks at this time of year. Frequently an added factor is noted under such conditions related to the hostility of the customers waiting in line to carry out such product exchanges. A multiplier of 2.0 may be appropriate for a period of time (10 shopping days, for example) after a period of increased product sales.

F. Restaurant Establishments

Many fast food establishments have crews that cover a specific increment of time (4 to 11 hours). To reduce labor expenses, an employer could reduce the number of workers by 25% to 30%. From this cost savings, an employer would put a 1.25 to 1.50 multiplier on those increments of times when there is an increase in functional demands during specific customer mealtimes. A fast food crew is busiest, for example, and is called on to put the meal together at an elevated speed to satisfy the influx of customers, at breakfast, lunch, and supper. A multiplier would be appropriate during these time increments to compensate for the increased functional demands placed upon the fast food crew. An employer would benefit from not being “over staffed” during off meal time periods.

It is anticipated that the employer would analyze the particular job functions of his employees and program the selected multipliers into time increments when there is a foreseeable “increase in the functional demands” on the worker for that increment of time. It is important that in order to get the maximum benefit of this computer assisted, interactive process, the program multipliers should be scheduled as far in advance as is practical so that the workers are cognizant of the game plan for the day before the work begins. Any changes to the multipliers in the form of the condition multipliers described above can be made at the last minute if such working conditions require adjustments to the pre-programmed multiplier values. However, in order to get the maximum benefit of the process, interactive adjustments should be kept to a minimum. Attention to detail should be part of the focus when multiplier values are programmed for future work days.

### Guaranteed Resource

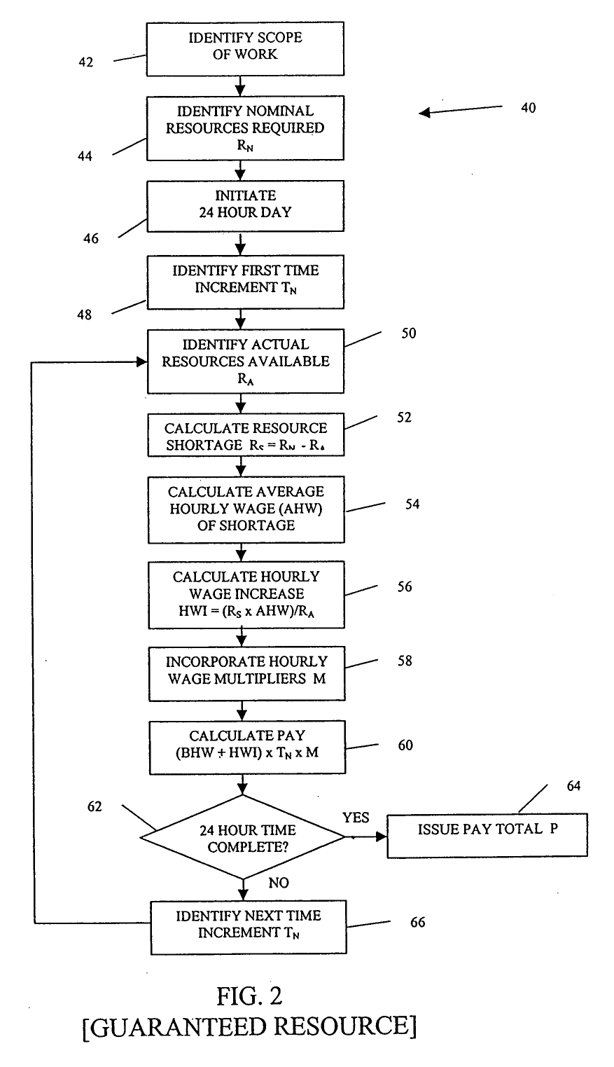

Reference is now made to FIG. 2 for a detailed description of the method of the present invention associated with improving job performance based upon guaranteeing the resource associated with the particular job. Method (40) described in FIG. 2 is initiated with step (42) wherein the scope of the work to be performed is identified. Step (44) involves identifying the nominal resources (R_{N}) required to perform the work identified. In step (46) the data processor initiates the 24-hour day calculation. In step (48) the processor identifies the first time increment (T_{N}) in the same manner as described above.

The data processor at step (50) identifies the actual resources (R_{A}) that are available for the project during the subject 24-hour period of time.

The processor then calculates the resource shortage (R_{S}) at step (52) as being the difference between the nominal resources required and the actual resources available:

(R_{S}=R_{N}−R_{A}).

In step (54) the processor calculates the average hourly wage (AHW) of the resource shortage, i.e. for the employees absent or otherwise not involved in the work.

The processor then at step (56) calculates the hourly wage increase (HWI) appropriate for each of the employees available as a resource. This calculation is:

HWI=(R_{S}×AHW)/R_{A}.

In step (58) hourly wage multipliers are incorporated into the calculation process. These hourly wage multipliers derive from the same process identified and described above with respect to FIG. 1.

The pay for the specific employee is then calculated at step (60) as being:

(BHW+HWI)×T_{N}×M.

The processor then determines whether the 24-hour time period has been completed at step (62). If not, at step (66) the processor identifies the next time increment (T_{N}) and returns to step (50) to again identify the actual resources available. If the 24-hour time has been completed at step (62), the processor issues the pay total (P) for that employee at step (64).

### Performance Incentives

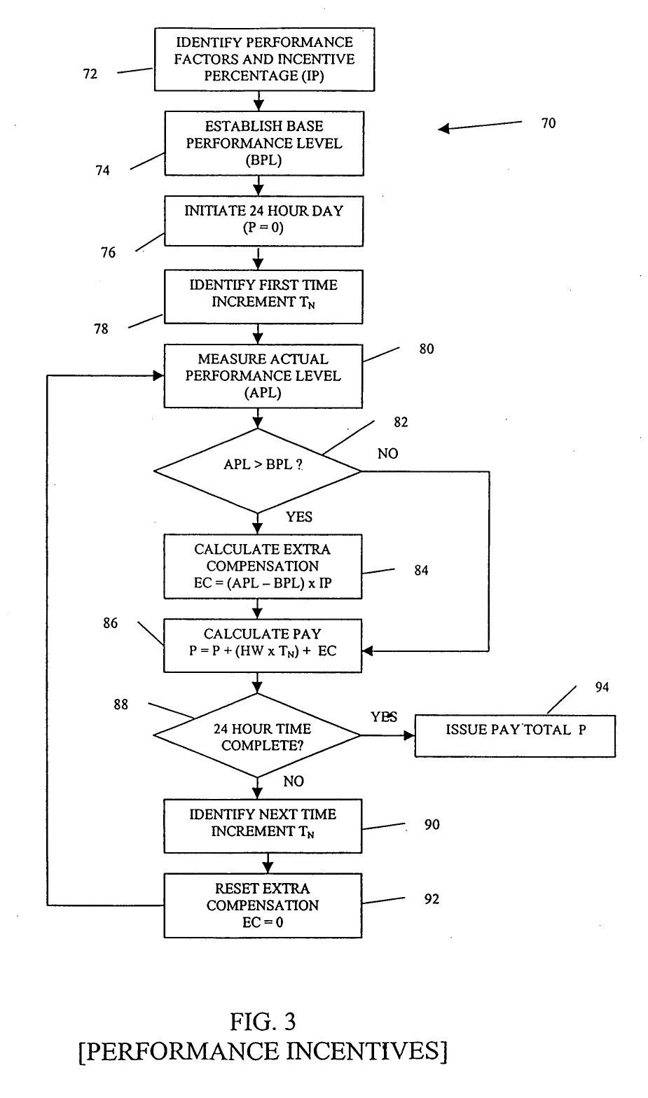

Reference is made finally to FIG. 3 for a detailed description of the method of the present invention associated with increasing compensation based upon employee performance. Method (70) shown in FIG. 3 is initiated at step (72) by identifying performance factors to be evaluated and the incentive percentage (IP) to be employed. At step (74) a base performance level (BPL) is established. At step (76) the 24-hour day is initiated with the pay (P) set to 0.

The processor at step (78) then identifies the first time increment (T_{N}) in the manner described above. In step (80) the actual performance level (APL) is measured for the employee in question. At step (82) the processor determines whether the actual performance level is greater than the base performance level. If so, at step (84) the extra compensation (EC) is calculated as follows:

EC=(APL−BPL)×IP.

The pay (P) is then calculated at step (86) being incremented as follows:

P=P+(HW×T_{N})+EC.

The processor then determines whether the 24-hour period is complete at step (88) If not the processor then identifies the next time increment (T_{N}) at step (90) and then proceeds through step (92) to reset the extra compensation (EC) to zero and to return to step (80) to again measure actual performance levels. Once the 24-hour time period is complete, the processor issues a pay total (P) at step (94).

Performance factors that could be utilized in conjunction with the process described in FIG. 3 are identified in Table 2. These performance factors are very much job dependent and may be utilized individually or in combination over specific time increments.

TABLE 2
Performance Factors

Item Sales per Time Increment
Dollar Sales per Time Increment
Customers per Time Increment
Service Item per Time Increment
Customer Satisfaction Index
Training Performance Index
Profit per Time Increment

Although the present invention has been described in conjunction with a number of specific embodiments and explained through the use of a number of examples it is anticipated that a variety of other embodiments and examples are possible without departing from the scope of the invention. Salaried employees could easily take advantage of the methods of the present invention by normalizing their salaries into nominal hourly wages. It is further to be understood that the examples of multipliers and compensation factors identified in the tables above are representative only and are far from exhaustive of the various factors that could be identified.

1. A data processor managed method for providing increased compensation of hourly wage and salaried employees based upon guaranteeing the resources for a job, the method comprising the steps of:
defining a portion of said job as a scope of work to be performed in a day;
determining a nominal resource of personnel required for completion of said scope of work;
identifying actual resources of personnel available to perform said scope of work, said actual resources of personnel comprising at least one worker having a base hourly wage;
calculating a resource shortage as a difference between said nominal resource of personnel and said actual resources of personnel;
determining an average hourly wage of said resource shortage;
calculating an hourly wage increase as a pro rated share of said average hourly wage of said resource shortage;
calculating total compensation for each of said at least one worker for said worker's contribution to the completion of said scope of work as equal to a period of time worked by said worker, multiplied by said base hourly wage of said worker plus said hourly wage increase; and
continuing said step of defining a portion of said job as a scope of work to be performed in a day through said step of calculating said worker's compensation until a day is completed; and
issuing a pay total for said worker, said pay total being the accumulated sum of pay for all of said portions of said job during said day.

2. The method of claim 1 wherein said step of defining a portion of said job as a scope of work comprises defining a specific percentage completion of said job.

3. The method of claim 1 wherein said job is a multipart job and said step of defining a portion of said job as a scope of work comprises defining one part of said multipart job.

4. The method of claim 1 wherein said step of determining a nominal resource comprises identifying an optimum number of workers and an optimum time period required for completion of said scope of work, said step of identifying actual resources comprises identifying a number of available workers and an available time period for completion of said scope of work, and step of calculating a resource shortage comprises identifying differences between said optimum and said available number of workers and said optimum and said available time period.

5. The method of claim 4 wherein said step of determining a nominal resource further comprises identifying an optimum set of skills of said workers, said step of identifying actual resources further comprises identifying an available set of skills of said workers, and step of calculating a resource shortage further comprises identifying differences between said optimum and said available set of skills of said workers.

6. The method of claim 1 wherein said step of determining a nominal resource comprises referencing historical performance records for the same or a similar defined scope of work.

7. The method of claim 1 wherein said step of determining an average hourly wage of said resource shortage comprises referencing historical compensation records for the same or a similar resource shortage.
